(19) United States
(12) Patent Application Publication
(10) Pub. No.: US 2010/0040733 A1
(43) Pub. Date: Feb. 18, 2010

(54) AROMA STABILIZING METHOD

(75) Inventors: Imre Blank, Savigny (CH); Christian Milo, Savigny (CH); Josef Kerler, Pully (CH); Christoph Mueller, Princeton, NJ (US); Thomas Hofmann, Neufahm (DE)

Correspondence Address: K&L Gates LLP, P.O. Box 1135, CHICAGO, IL, 60690, US

(73) Assignee: NESTEC S.A., Vevey (CH)

(21) Appl. No.: 12/440,151

(22) PCT Filed: Sep. 12, 2007
(86) PCT No.: PCT/EP07/59588

§ 371 Date: Mar. 5, 2009

(30) Foreign Application Priority Data
Sep. 15, 2006 (EP) 06019397.6

(51) Int. Cl. A23F 5/18; A23F 5/26

(52) U.S. Cl. 426/45; 426/271; 426/520; 426/442; 426/595; 426/432; 426/387

(57) ABSTRACT

The present invention provides a method for stabilising the aroma of aroma-rich foodstuffs and their products by reducing the amount of phenols derived from decomposition of polyphenols contained therein. The invention also describes aroma-stabilized foodstuffs as well as their products having a desirable flavour.

### FIELD OF THE INVENTION

The invention relates to a method for stabilizing the aroma of aroma-rich foodstuffs, in particular coffee and their products to improve their flavouring, taste or other desirable sensory characteristics. The invention also relates to aroma-stabilized foodstuffs as well as their products having a desirable flavour.

### BACKGROUND OF THE INVENTION

Aromas are an important part of many products since a consumer associates certain aromas with certain products. If the product lacks the aroma associated with it, consumer perception of the product is adversely affected. This association is very strong in the field of coffee products, but also in other food categories. This is particularly a problem in the field of soluble coffee powders, although it also exists in other fields.

For example, delicate coffee aroma is often degraded, or partially lost during the processing as seen in instant coffee and ready-to-drink manufacturing methods. Also, coffee aroma is known to be very unstable. As coffee aroma degrades, the aroma fades and unpleasant and non-coffee-like notes that are undesirable are generated. This degradation substantially reduces the perceived quality of the product. For this reason, special attention must be paid to the preparation and storage of flavouring components such as coffee aroma so that desirable aroma components are enhanced or undesirable components are reduced or eliminated.

EP 0 861 596 A1 describes a way to stabilise liquid coffee which results in a longer shelf-stable product. The method involves treating the extract with an alkali, followed by neutralisation and adjusting the pH value of the coffee to the desired final value. Conventionally, flavour protective agents can be added to aroma-rich food or beverage products in order to preserve, maintain or improve the flavour characteristics of such products. JP 2002-119210 relates to the prevention of deterioration of the aroma or flavour of coffee extract during heating or storage by adding peptides and/or amino acids, tocopherols and polyphenols to the extract. Similarly, JP 03-108446 also discloses the addition of an antioxidant, e.g. less than 1% of tocopherol, L-ascorbic acid, or polyphenolic compound in order to prevent deterioration of coffee drinks and preserve flavour during the extraction process. An increase in the stability and taste/aroma of coffee is also disclosed in WO2006/022764 by combining the coffee product with an antioxidant selected from flavanoids, polyphenols and/or phenolic acids. The prior art also describes sulphur containing compounds as flavour protective agents.

In addition, the prior art proposes processes where the coffee aromas are recovered at several points during processing of the soluble coffee and most commonly during and after grinding of the roasted beans as well as by steam stripping the coffee extract prior to concentration and drying. EP 1 355 536 A1 for example discloses a way to improve the post-processing amount of polyphenols of ground coffee beverage substrate.

By-products of coffee processing have also been reduced in coffee extracts for health purposes as described in WO 2005/072531 and WO2005/072533.

It has been shown, however, that the processes and approaches of the prior art are not entirely satisfactory with respect to enhancing desirable aroma components, reducing undesirable components and preserving volatile flavouring components. Many of the conventional aroma treated foods still fail to have the desired flavour, taste and other sensory characteristics.

It is object of the present invention to provide a technology to further stabilize the aroma of aroma-rich foodstuffs to provide improved high aroma qualities in terms of freshness and persistent aroma.

### SUMMARY OF THE INVENTION

The invention provides a method for stabilizing the aroma of aroma-rich foodstuffs and their products by reducing the amounts of phenols derived from decomposition of polyphenols contained therein.

It has been surprisingly found that the method of the present invention allows a significant reduction of specific phenols and thus provides significantly larger amounts of aroma components, which get usually lost during processing of the aroma-rich foodstuffs such as coffee, tea and cocoa. The major benefit is improved aroma-rich foodstuff quality in terms of freshness, persistent aroma, etc. upon reconstitution and consumption as well as a significantly extended shelf-life.

Reduction of the amount of phenols contained in the aroma-rich foodstuffs predominantly results in a significant reduction of hydroxyhydroquinone (HHQ) which is a phenol generated upon roasting of the aroma-rich foodstuffs such as coffee. HHQ is a non-volatile phenol which traps thiols and generates hydrogen peroxides leading to degradation of coffee flavour compounds and thus to a distortion of the overall coffee flavour.

Thiols are known to be key odorants in coffee aroma. One of the most important thiols that contribute to coffee aroma is 2-furfurylthiol (FFT). It has been surprisingly found that a significant reduction of the HHQ amount avoids losses of coffee thiols such as FFT. The reduction of HHQ in roasted coffee solutions (e.g. extracts of roasted coffee) is achieved by treatments leading to the degradation or removal of HHQ so that the thiols remain in the aroma-rich coffee to display the whole range of aroma. Thus, the higher amounts of thiols help in keeping the full freshness of the aroma.

The invention further provides aroma-stabilized foodstuffs having a reduced content of phenols, particularly hydroxyhydroquinone (HHQ), and a higher content of thiols such as FFT. The aroma-stabilized foodstuffs of the present invention have an improved aroma quality in terms of freshness, persistent aroma, etc. upon reconstitution and consumption as well as a significantly extended shelf life.

The invention also provides aroma-stabilized foodstuffs obtainable by the method of the invention.

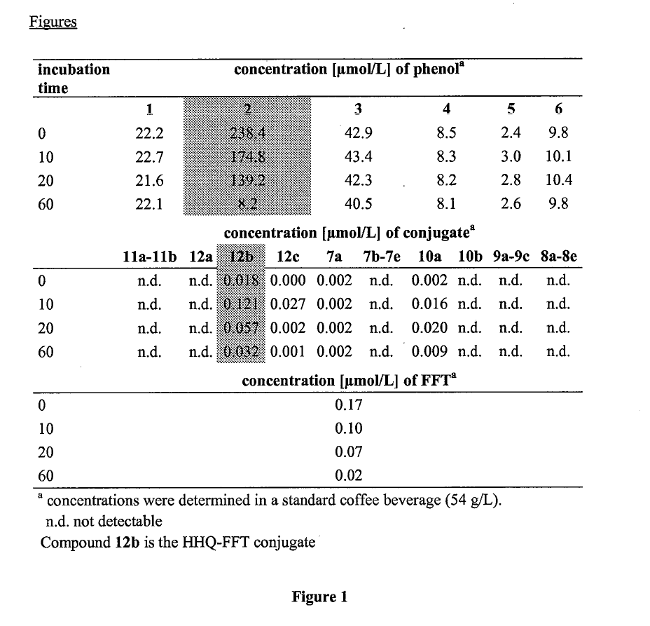

The present invention is further illustrated by means of the accompanying FIG. 1.

FIG. 1 is a table illustrating the concentrations of 2-furfurylthiol (FFT), di-/trihydroxybenzenes and phenol/FFT-conjugates during storage of coffee beverages.

### DETAILED DESCRIPTION OF THE PREFERRED EMBODIMENTS OF THE INVENTION

The principles of the invention are now illustrated for the preferred embodiments where coffee aroma is described as the most preferred aroma. Coffee aroma is used as a flavouring agent for various foods or beverages and particularly in soluble coffee, coffee concentrate and ready-to-drink coffee beverages to improve the flavour, taste and other sensory characteristics of the beverages. In general, however, the improved aromas of this invention are intended to be a generic definition of all types of aromas, including also chocolate or cocoa aroma or tea aroma and many other aromas, which can be found in aroma-rich foodstuffs.

The method of the invention is applicable to the total aroma-rich foodstuff or after having removed the aroma from this foodstuff. Preferably, the foodstuff is treated after having removed the aroma.

Preferably, the aroma-rich foodstuffs are coffee, tea and cocoa and their products. More preferred, the aroma of coffee is stabilized by the process of the present invention in the final product. The aroma is also further enhanced.

The aroma stabilizing method of the present invention comprises reducing the amount of phenols derived from decomposition of polyphenols contained in the aroma-rich foodstuffs, which usually arise when roasting the natural foodstuff materials such as coffee beans, tea leaves and cocoa beans.

In a preferred embodiment of the invention, the amount of phenols is reduced to a range between 30 to almost 100%. In a particularly preferred embodiment, the amount of phenols is reduced by at least 50%, most preferred to an extent of almost 100%.

The phenols in coffee are generally decomposition products of chlorogenic acids such as 5-O-caffeoyl quinic acid, which is the major phenolic compound found in coffee. They may also be derived from the reaction of carbohydrates and amino acids (Maillard reaction). Tea and cocoa contain other types of polyphenols. During the roasting process 5-O-caffeoyl quinic acid is thermally decomposed to give hydroxyhydroquinone (HHQ) and other di- and trihydroxybenzenes. Examples of the di- and trihydroxybenzenes are pyrogallol, catechol, 4-ethylcatechol, 4-methylcatechol and 3-methylcatechol.

Hydroxyhydroquinone (HHQ) has been shown to play the important role in the degradation of thiols, which are known to be key odorants in coffee aroma. HHQ traps the thiols by forming conjugates and generates hydrogen peroxides leading to degrading of coffee flavour compounds and thus to a distortion of the overall coffee flavour. One of the crucial thiols is 2-furfurylthiol (FFT) present, for example, in coffee. This key thiol has indeed been shown to contribute to the desirable an fresh aroma in coffee.

As shown in FIG. 1, which shows the correlation of the concentrations [μmol/L] of 2-furfurylthiol (FFT), di-/trihydroxybenzenes and phenol/FFT-conjugates during storage of coffee beverages, the decrease in HHQ that naturally occurs in a coffee beverage upon storage at e.g. 30° C. is well correlated with a decrease in FFT concentration as well as with the increase of the corresponding HHQ/FFT conjugate. The other di-/trihydroxybenzenes are present in the coffee brew in much lower amounts than the HHQ and do not change so much in concentration compared to HHQ. This shows the importance of HHQ in the degradation of thiols.

In FIG. 1, the phenols tested are 1=pyrogallol, 2=hydroxyhydroquinone, 3=catechol, 4=4-ethylcatechol, 5=4-methylcatechol und 6=3-methylcatechol. The incubation time is in minutes, and the conjugate 12b corresponds to a HHQ/FFT conjugate. (preferably clarify also what the other conjugates are).

As there is a large excess of HHQ compared to FFT, it is preferred according to the process of the present invention to reduce the amount of hydroxyhydroquinone (HHQ) while it is advantageous to remove the other di- and trihydroxybenzenes simultaneously. As a result, the original FFT is better maintained.

In a preferred embodiment of the present invention, the amount of hydroxyhydrochinone (HHQ) is reduced by at least 30%, more preferred by at least 50%, particularly preferred to an extent up to almost 100%.

The amount of phenols is reduced by chemical and/or physical means to remove or inactivate the phenols.

In the following, a number of options is listed for a significant reduction of the phenol amount, in particular the HHQ amount, to avoid losses of coffee thiols such as FFT. The processes indicated are intended to lead to a degrading or removal of HHQ.
i) Physical removal of the phenols by filtration. Suitable filtrations means are, for example, membranes, molecular imprints (MIPs) and dialysis membranes;
ii) Separation of the phenols by ion-exchange resins such as anion exchange resins, metal cation chelate resins;
iii) Decomposition of the phenols induced by heat (using temperatures between 20 and 100° C.), change in pH in the range between 3 and 10, preferably between 5 and 8, oxidation, for example by forced exposure to oxygen (e.g. by bubbling oxygen through the coffee beverage or extract in an amount that is equivalent to 1 to 50 times the volume of the used coffee beverage or extract) and enzyme treatment, or a combination thereof;
iv) Chemical trapping of the phenols by using nucleophiles. Examples of suitable nucleophiles are selected from sulfur-containing compounds such as SO₂, sulphite salts, and thiols or a substance that contains or generates a sulfite, a thiol, an amine or an amino acid such as cysteine;
v) Reduction of oxygen generated in coffee (or any other aroma-rich foodstuff) processing to reduce the formation of HHQ-adducts and
vi) Selective extraction of the phenols by supercritical CO₂.

The methods described under i) to vi) may be used singly or may be also used in combination. The methods can be integrated at any stage in conventional foodstuff processing, as can be easily realized by the person skilled in the art.

In a particular embodiment, the present invention proposes a method for reducing the amount of HHQ in an aroma-rich foodstuff by heat treatment, change in pH, oxidation treatment, use of nucleophiles or any combinations thereof.

In a most preferred embodiment, a coffee extract is heated to 60° C. for 90 minutes with simultaneous oxidation treatment. Thus, more than 50% reduction on the original HHQ content is achieved.

The method of the present invention is applicable to aroma-rich foodstuffs of any provenience. Particularly preferred are aroma-rich foodstuffs such as coffee, tea and cocoa as well as their products. Particularly preferred is coffee the aroma of which is perfectly stabilised by the method of the present invention.

As an example, roasted and ground coffee particles are extracted with water to form a solution. If required, volatiles are stripped from the solution with steam to obtain an aroma concentrate. The extract solution containing the phenols is then treated with the above chemical/physical means.

In another embodiment, the aroma is first stripped from the roasted and ground coffee and then the coffee particles are subjected to the water extraction. In both cases, the solution treated with the chemical/physical means being essentially devoid of the phenols is then combined with the aroma concentrate.

Preferably, the solution treated with the chemical/physical means, which is essentially free of phenols, in particular HHQ, is combined with the aroma concentrate. If desired, the aroma components in the aroma liquid may be concentrated prior to being added to the concentrated extract. Concentration may be carried out using conventional procedures such as partial condensation, rectification, membrane concentration and freeze concentration. Also, the frost obtained from the cryogenic aroma collector may be added to the concentrated extract.

The aromatized extract is then dried in usual manner to provide an aromatized, soluble coffee powder, for example, by spray- or freeze-drying. Of course, the aroma liquid and aroma frost may be used for other aromatization purposes.

The method of the present invention is particular suitable for stabilizing coffee aroma for beverages selected from soluble coffee, coffee concentrate and ready-to-drink coffee.

Aromatized, soluble coffee powder may be reconstituted as usual to provide a coffee beverage.

The present invention also provides aroma-stabilized foodstuffs having a reduced content of phenols derived from decomposition of polyphenols. Preferably, the aroma-stabilized foodstuffs are essentially free of said phenols, with a content of phenols being reduced to 30 to almost 100%. Most preferred, the aroma-stabilized foodstuffs of the present invention are those where the content of phenols is reduced to almost 100%.

In a particular embodiment, a coffee composition comprising 100-500 ppm (based on coffee solids) HHQ and 0.5-10 ppm (based on coffee solids) 2-furfurylthiol. Preferably, the coffee composition is selected from soluble coffee, coffee concentrate and ready-to-drink coffee.

The relative reduction of the amount of hydroxyhydroquinone (HHQ) in the treated coffee samples of the present invention can be conveniently and accurately determined compared to the untreated sample using the method described by C. Müller et al. in J. Agric. Food Chem. 2006, 54, 10086-10091.

The impact of hydroxyhydroquinone (HHQ) removal on the enhanced presence of key aroma impact compounds like FFT in a treated coffee sample compared to the untreated sample is determined using a direct headspace sampling GC-MS detection This method involves the addition of an aqueous solution of FFT (e.g. 1 mL of 500 μg in 0.1 mol/L phosphate buffer, pH 5.7) to the untreated and treated coffee beverage, respectively). Alternatively, no FFT addition could be applied if the natural FFT content of the coffee beverage (no prior aroma removal to the treatment) is targeted. The coffee beverage is then incubated/treated in a temperature controlled, septum sealed vial or vessel at e.g. 30° C. for a time between 10 and 60 min. An aliquot (1-2.5 mL) of the headspace above the beverage was then sampled from the closed vial through the septum using a gas tight syringe. The headspace sample was then analysed by HRGC-MS. Relative contents were determined by integrating peak areas of the mass fragments m/z 114 or 81 in the untreated and treated coffee beverage relative to a control (FFT in 0.1 mol/L phosphate buffer solution of e.g. pH 5.7).

Preferably, the aroma stabilized foodstuff of the present invention is coffee essentially free of hydroxyhydroquinone (HHQ) and, optionally, other di- and trihydroxybenzenes. Examples of the di- and trihydroxybenzenes are as mentioned above.

A number of different specific beverage-forming components are provided by dramatically reducing the content of phenols, specifically hydroxyhydroquinone (HHQ). One product is a coffee concentrate in liquid form. Another product is ready-to-drink coffee. Included is also soluble coffee obtained by freeze-drying or spray-drying the coffee concentrate. The aromatized, soluble coffee powder may then be reconstituted as usual to provide a coffee beverage.

Other aroma-stabilized products of the present invention are, for example, those based on tea, cocoa and their products.

The present invention also provides an aroma-stabilized foodstuff obtainable by a method as explained above.

Specific examples of the invention are now described to further illustrate the invention.

### EXAMPLES

### Example 1

54 g of roast and ground (“R&G”) coffee is extracted with water (1 L of a temperature of ca. 95° C.) to form a coffee extract. The coffee extract was analysed for di-/trihydroxybenzenes such as HHQ and free FFT contents as well as the corresponding HHQ/FFT conjugate using the methods described above.

Table 1 is a table illustrating the change in concentrations of 2-furfurylthiol (FFT), di-/trihydroxybenzenes and phenol/FFT-conjugates during heat treatment of the coffee beverage at 30° C. up to 60 min.

The phenols tested are 1=pyrogallol, 2=hydroxyhydroquinone, 3=catechol, 4=4-ethylcatechol, 5=4-methylcatechol und 6=3-methylcatechol.

The concentration of hydroxyhydroquinone (HHQ) in the coffee beverage is 238.4 μmol/L immediately after brewing the coffee. The amount of HHQ decreases by ca. 97% during 60 minutes. The other di-/trihydroxybenzenes are present in the coffee brew in much lower amounts than the HHQ and do not change so much in concentration compared to HHQ.

TABLE 1

| | |
|---|---|
| incubation | concentration [μmol/L] of phenol^{a} |

| time (min) | 1 | 2 | 3 | 4 | 5 | 6 |
|---|---|---|---|---|---|---|
| 0 | 22.2 | 238.4 | 42.9 | 8.5 | 2.4 | 9.8 |
| 10 | 22.7 | 174.8 | 43.4 | 8.3 | 3.0 | 10.1 |
| 20 | 21.6 | 139.2 | 42.3 | 8.2 | 2.8 | 10.4 |
| 60 | 22.1 | 8.2 | 40.5 | 8.1 | 2.6 | 9.8 |

| | concentration [μmol/L] of conjugate^{b} | | | | | | | | | |
|---|---|---|---|---|---|---|---|---|---|---|
| | 11a-11b | 12a | 12b | 12c | 7a | 7b-7e | 10a | 10b | 9a-9c | 8a-8e |
| 0 | n.d. | n.d. | 0.018 | 0.000 | 0.002 | n.d. | 0.002 | n.d. | n.d. | n.d. |
| 10 | n.d. | n.d. | 0.121 | 0.027 | 0.002 | n.d. | 0.016 | n.d. | n.d. | n.d. |
| 20 | n.d. | n.d. | 0.057 | 0.002 | 0.002 | n.d. | 0.020 | n.d. | n.d. | n.d. |
| 60 | n.d. | n.d. | 0.032 | 0.001 | 0.002 | n.d. | 0.009 | n.d. | n.d. | n.d. |

| | concentration [μmol/L] of FFT^{a} |
|---|---|
| 0 | 0.17 |
| 10 | 0.10 |
| 20 | 0.07 |
| 60 | 0.02 |

^{a}concentrations of pyrogallol (1), hydroxyhydroquinone (2), catechol (3), 4-ethylcatechol (4), 4-methylcatechol (5) and 3-methylcatechol (6) were determined in a standard coffee beverage (54 g/L) as a function of the incubation/storage time (T = 30° C.).
n.d. not detectable
^{b}concentrations of the following FFT-phenol conjugates were determined in a standard coffee beverage (54 g/L) as a function of the incubation/storage time (T = 30° C.): 3-((2-furfurylmethyl)sulfanyl)catechol (7a), 3,5-bis((2-furfurylmethyl)sulfanyl)catechol (7b), 4,5-bis((2-furfurylmethyl)sulfanyl)catechol (7c), 3,4,6-tris((2-furfurylmethyl)sulfanyl)catechol (7d), 3-((2-furfurylmethyl)sulfanyl)-4-((2-(3-(2-furfurylmethyl)sulfanyl)-furylmethyl)sulfanyl)catechol (7e), 4-((2-furfurylmethyl)sulfanyl)-3-methylcatechol (8a), 3-((2-furfurylmethyl)sulfanyl)-6-methylcatechol (8b), 3,4-bis((2-furfurylmethyl)sulfanyl)-6-methylcatechol (8c), 3,5-bis((2-furfurylmethyl)sulfanyl)-6-methylcatechol (8d), 3,4,5-tris((2-furfurylmethyl)sulfanyl)-6-methylcatechol (8e), 3-((2-furfurylmethyl)sulfanyl)-5-methylcatechol (9a), 3,4-bis((2-furfurylmethyl)sulfanyl)-5-methylcatechol (9b), 3,6-bis((2-furfurylmethyl)sulfanyl)-4-methylcatechol (9c), 3-((2-furfurylmethyl)sulfanyl)-5-ethylcatechol (10a), 3,6-bis((2-furfurylmethyl)sulfanyl)-4-ethylcatechol (10b), 4-((2-furfurylmethyl)sulfanyl)pyrogallol (11a), 4,5-bis((2-furfurylmethyl)sulfanyl)pyrogallol (11b), 3-((2-furfurylmethyl)sulfanyl)hydroxyhydrochines (12a), 4-((2-furfurylmethyl)sulfanyl)hydroxyhydrochines (12b; HHQ-FFT conjugate: key reaction product of this invention), 3,4-bis((2-furfurylmethyl)sulfanyl)hydroxyhydrochinone (12c)

The concentration [μmol/L] of the phenol/FFT-conjugates clearly indicates very high values for the HHQ/FFT-conjugate (column 12b). After 10 minutes storage, the conjugate concentration is increased to 0.121 μmol/L (67%). Further treatment of coffee beverage leads to a relative decrease of the conjugate, which can be explained by further reaction (e.g. polymerisation). In parallel, significant amounts of natural FFT were lost, that is from 0.17 μmol/L to 0.10 μmol/L (41%). The other phenol conjugates (conjugates of FFT with tested phenols 1 and 3-6) are present in much minor amounts, partially in amounts, which are no more detectable. This shows the importance of HHQ in the degradation of thiols.

### Example 2

A roast and ground (“R&G”) 100% Colombia coffee is extracted with water to form a coffee extract. The extract is passed through a steam stripping column where the volatile flavour/aroma components are stripped, condensed and collected as aroma distillate.

The HHQ concentration has been measured to give 21.6 mg/l HHQ in the extract.

This extract is then submitted to a forced oxygen exposure, by bubbling oxygen through the solution (700 ml) with a constant flow rate of ˜20 ml/min. Preferably this treatment is done at elevated temperatures, e.g. 60° C. for up to 2 hours.

The HHQ concentration has been measured to provide 9.8 mg/l HHQ in the extract as treated above. This corresponds to a decrease of HHQ by approx. 50% in the coffee extract and represent a significant reduction of HHQ compared to the untreated extract.

The extract was evaporated, aroma added and then dried to a soluble coffee powder using normal process conditions known to the person skilled in the art. Upon reconstitution of this powder with hot water, the resulting beverage was perceived as having a longer lasting, more intense aroma with increased freshness compared to the extract without oxygen treatment.

### Example 3

The volatile flavour/aroma components are stripped from a roast and ground (“R&G”) coffee, condensed and collected as aroma distillate. The aroma depleted coffee is then extracted with water to form a coffee extract.

The pH of the coffee extract is adjusted to pH 8 with an inorganic base, preferably potassium hydroxide, and heated for 90 min at an elevated temperature (e.g. 60° C.) in a closed system. The pH was re-adjusted to the initial value pH 5.2. The HHQ concentration in the treated extract was reduced to 40% compared to an untreated sample.

After adding back the aroma the resulting beverage was perceived as having a longer lasting aroma with increased freshness compared to the extract without alkaline treatment.

### Example 4

The volatile flavour/aroma components are stripped from a roast and ground (“R&G”) coffee, condensed and collected as aroma distillate. The aroma depleted coffee is then extracted with water to form a coffee extract.

The pH of the coffee extract is adjusted to pH 8 with an inorganic base, preferably potassium hydroxide, and heated for 90 min at an elevated temperature (e.g. 60° C.), while bubbling oxygen through the solution at a rate of 3× the coffee volume/hour. The pH was re-adjusted to the initial value pH 5.2. The HHQ concentration in the treated extract was reduced to ˜7% compared to an untreated sample.

After adding back the aroma the resulting beverage was perceived as having a longer lasting aroma with increased freshness compared to the extract without alkaline and oxygen treatment.

### Example 5

An aroma stripped coffee extract as described in the previous samples can be alternatively treated by a nucleophile known to react with HHQ preferably after oxygenation of the sample. Thus, after bubbling oxygen through a coffee extract (90 min; 60° C.) with a solid matter content of about 10 to 14% at a rate of 3× the coffee volume/hour, 200 ppm of sulfite in form of its sodium salt were added to the extract and reacted for 90 minutes at room temperature.

After adding back the aroma, the resulting beverage was perceived as having a longer lasting aroma with increased freshness compared to an extract without this treatment.

1. Method for reducing the amount of hydroxyhydroquinone (HHQ) in an aroma-rich foodstuff by subjecting the foodstuff to a process step selected from the group consisting of heat treatment, change in pH, oxidation treatment, use of nucleophiles and combinations thereof.

2. Method according to claim 1, wherein the foodstuff is coffee.

3. Method according to claim 1, wherein the heat treatment comprises subjecting the foodstuff to a temperature of between 20 and 90° C. for a period of time up to 2 hours.

4. Method according to claim 1, wherein the process step of a change in pH comprises increasing the pH of the foodstuff to a pH value of 7 to 9 and reducing the pH back to the foodstuff's initial value.

5. Method according to claim 1, wherein the oxidation treatment comprises the step of a forced exposure to oxygen of the foodstuff.

6. Method according to claim 1, wherein the use of nucleophiles comprises treating the foodstuff with sulfur-containing compounds or a substance that contains or generates a sulfite, a thiol, an amine or an amino acid.

7. Coffee composition comprising 100-500 ppm, based on coffee solids, HHQ and 0.5-10 ppm, based on coffee solids, 2-furfurylthiol.

8. Coffee composition according to claim 7, which is selected from the group consisting of soluble coffee, coffee concentrate and ready-to-drink coffee.

9. A method for stabilising the aroma of aroma-rich foodstuffs and their products comprising the step of reducing the amount of phenols derived from decomposition of polyphenols contained therein.

10. The method of claim 9, wherein the amount of phenols is reduced by 30 to almost 100%.

11. The method of claim 10, wherein the amount of phenols is reduced by almost 100%.

12. The method of claim 9, wherein the amount of phenols is reduced by a means selected from the group consisting of chemical and physical means to remove or inactivate the phenols.

13. The method of claim 9, wherein the amount of phenols is reduced by a step selected from the group consisting of filtration, separation by ion exchange resins, decomposition by heat, change in pH, oxidation and enzyme treatment, use of nucleophiles, reduction of oxygen and selective extraction by supercritical CO₂.

14. The method of claim 13, wherein the phenols are filtered off by using a filter selected from the group consisting of membranes, molecular imprints and dialysis membranes.

15. The method of claim 13, wherein the nucleophiles are selected from the group consisting of SO₂, a sulfite and a substance that contains or generates an amine or an amino acid.

16. The method of claim 9 wherein the aroma-rich foodstuff is selected from the group consisting of coffee, tea and cocoa and their products.

17. The method of claim 16 wherein the aroma of coffee is stabilised.

18. The method of claim 17 wherein the phenols are decomposition products of chlorogenic acids and comprise hydroxyhydroquinone (HHQ) and other di- and trihydroxybenzenes.

19. The method of claim 18 wherein the amount of hydroxyhydroquinone (HHQ) is reduced.

20. The method of claim 16 wherein roasted and ground coffee particles are extracted with water to form a solution, volatiles are stripped from the solution with steam to obtain an aroma concentrate and the solution is treated with the chemical/physical means.

21. The method of claim 20 wherein the solution treated with the chemical/physical means is combined with the aroma concentrate.

22. The method of claim 20 wherein the aroma of coffee is stabilized for beverages selected from the group consisting of soluble coffee, coffee concentrate and ready-to-drink coffee.

23. Aroma-stabilized foodstuff obtained by the method of claim 9.

24. Aroma-stabilized coffee having a reduced content of hydroxyhydroquinone (HHQ) and other di- and trihydroxybenzenes

25. The aroma-stabilized foodstuff of claim 24, wherein the content of hydroxyhydroquinone (HHQ) and other di- and trihydroxybenzenes is reduced by 30 to almost 100%.

26. The aroma-stabilized foodstuff of claim 25, wherein the content of hydroxyhydroquinone (HHQ) and other di- and trihydroxybenzenes is reduced by almost 100%.

27. The aroma-stabilized coffee of claim 24, wherein the coffee is selected from the group consisting of soluble coffee, coffee concentrate and ready-to-drink coffee.
